(19) United States
(12) Patent Application Publication
(10) Pub. No.: US 2023/0221758 A1
(43) Pub. Date: Jul. 13, 2023

(54) PORTABLE MONITOR WORKSTATION

(71) Applicant: Steven Daluz, Vancouver (CA)

(72) Inventor: Steven Daluz, Vancouver (CA)

(21) Appl. No.: 17/647,886

(22) Filed: Jan. 13, 2022

(51) Int. Cl. G06F 1/16

(52) U.S. Cl. CPC G06F 1/1616; G06F 1/1628; G06F 1/1647; G06F 1/1656; G06F 1/1681

(57) ABSTRACT

A portable workstation that is configured to be operably coupled to a portable computing device wherein the workstation of the present invention provides a larger display to view. The portable workstation includes a first display monitor and a second display monitor that are hingedly coupled via a movement member. The first display monitor and second display monitor are movable intermediate a first position and a second position. The first display monitor and a second display monitor are placed in an elevated position with a mount once in the second position. A keyboard is movably secured to the portable workstation and is movable so as to be intermediate the first display monitor and the second display monitor in their first position. The first display monitor and second display monitor are controlled via a control panel that is configured to provide the necessary electronics for wireless communication to a portable computing device.

### FIELD OF THE INVENTION

The present invention relates generally to portable computing workstations, more specifically but not by way of limitation, a portable dual monitor workstation configured to be operably coupled to laptop computer wherein the present invention provides folding dual monitors and can further provide a full size keyboard.

### BACKGROUND

As is known in the art, portable computing devices such as but not limited to tablet PC's and laptops are widely utilized. The conventional laptop computer includes a foldable housing wherein the housing includes both a monitor and a keyboard. Laptop computers are now more commonly issued to workers in corporate environments instead of conventional desktop computers due to some of the advantages that the laptop computer provides the user. The laptop requires less desk space and further allows a worker to utilize their computer to execute their required tasks with the ability to perform them from a variety of locations as well as bring their laptop to meetings. While the laptops offer several advantages to desktop computers, there are drawbacks to the use of laptop computers.

One issue with the laptop computer is the small screen size. An average laptop computer screen is thirteen inches as compared to a twenty-four-inch screen that is the most common size for a desktop. The smaller screen size makes utilizing some applications and more than one application more cumbersome. Another issue with the conventional laptop computer is the smaller keyboard. While laptop computers do provide a full keyboard, the physical size is smaller for which some can find use thereof inconvenient.

Accordingly, there is a need for a portable workstation configured to be operably coupled to a laptop computer, wherein the portable workstation of the present invention provides dual monitors and further provides a full size keyboard that is operable to be foldable and easily transported.

### SUMMARY OF THE INVENTION

It is the object of the present invention to provide a workstation that is configured to be operably coupled to a laptop computer wherein the present invention includes a frame having a first display monitor and a second display monitor.

Another object of the present invention is to provide a portable workstation configured with a first monitor and a second monitor wherein the portable workstation of the present invention further includes a keyboard.

A further object of the present invention is to provide a workstation that is configured to be operably coupled to a laptop computer wherein the first display monitor and a second display monitor are movable between a first position and a second position.

Still another object of the present invention is to provide a portable workstation configured with a first monitor and a second monitor wherein the portable workstation of the present invention utilizes a wireless communication protocol such as but not limited to Bluetooth to operably coupled to a laptop computer.

An additional object of the present invention is to provide a workstation that is configured to be operably coupled to a laptop computer wherein in the first position the first display monitor and the second display monitor are facing each other and are further adjacent.

Yet a further object of the present invention is to provide a portable workstation configured with a first monitor and a second monitor wherein in the second position the first display monitor and second display monitor are oriented in a linear manner.

Another object of the present invention is to provide a workstation that is configured to be operably coupled to a laptop computer wherein the portable workstation further includes at least one movement member configured to move the first display monitor and the second display monitor between the first position and the second position.

Still another object of the present invention is to provide a portable workstation configured with a first monitor and a second monitor wherein the keyboard is positioned intermediate the first display monitor and the second display monitor in the first position of the workstation.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of the present invention in its second position;

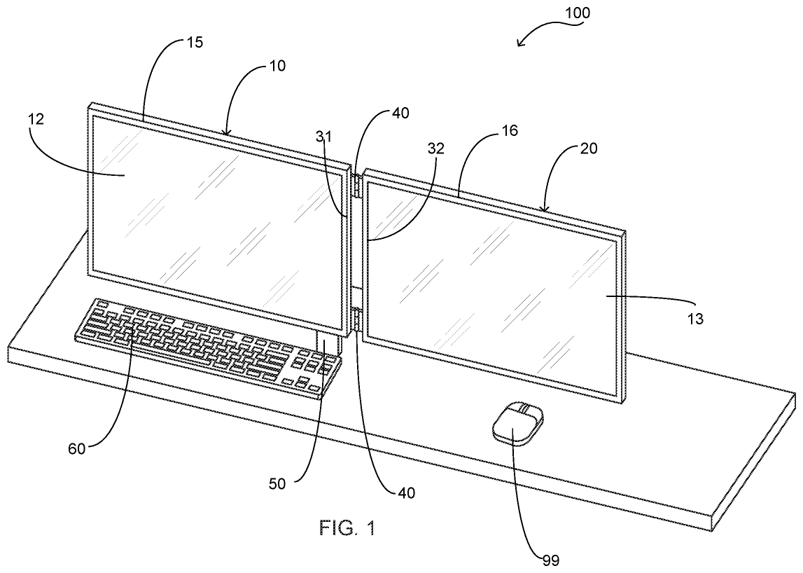

and

FIG. 2 is a perspective view of the present invention in its first position.

### DETAILED DESCRIPTION

Referring now to the drawings submitted herewith, wherein various elements depicted therein are not necessarily drawn to scale and wherein through the views and figures like elements are referenced with identical reference numerals, there is illustrated a portable workstation 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted as a part hereof, the portable workstation 100 includes a first display monitor 10 and a second display monitor 20. The first display monitor 10 and second display monitor 20 are configured to be suitable for computer display imaging having the necessary resolution and size. It should be understood within the scope of the present invention that the first display monitor 10 and second display monitor 20 could various sizes with twenty-four inches being a preferred embodiment. Furthermore, while the first display monitor 10 and the second display monitor 20 could be provided in various thicknesses, it is contemplated within the preferred embodiment that the first display monitor 10 and the second display monitor 20 are one-quarter inch in thickness. While not particularly illustrated herein, the first display monitor 10 and second display monitor 20 are electrically coupled to a suitable power supply. It is further contemplated within the scope of the present invention that the first display monitor 10 and second display monitor 20 could include an integrated rechargeable power supply such as but not limited to a lithium ion battery for providing the necessary power for operation thereof.

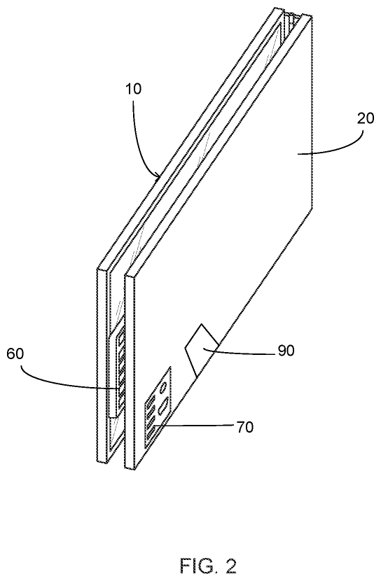

The first display monitor 10 and second display monitor 20 each include housings 15, 16 and screens 12, 13. The housings 15, 16 of the first display monitor 10 and the second display monitor 20 are hingedly coupled along inner edges 31, 32. The hinged coupling of the first display monitor 10 and second display monitor 20 is executed via movement members 40. The movement members 40 are secured to the inner edges 31, 32 of the housing 15, 16 and provide movement of the first display monitor 10 and the second display monitor 20 between their first position and second position. In their first position, the first display monitor 10 and the second display monitor 20 are folded such that the screens 12, 13 are facing each other and adjacent. The first position is illustrated herein in FIG. 2. In the second position of the first display monitor 10 and the second display monitor 20 the housings 15, 16 are axially aligned so as to face the screens 12, 13 outward. The movement members 40 are secured to the housings 15, 16 utilizing suitable techniques. While two movement members 40 are illustrated herein, it is contemplated within the scope of the present invention that the portable workstation 100 could have more or less than two movement members 40.

The first display monitor 10 is secured to mount 50. Mount 50 provides an elevated position for the portable workstation 100 ensuing being superposed a suitable horizontal support surface such as but not limited to a desktop or a table. The mount 50 is manufactured from a suitable rigid, lightweight material such as but not limited to metal. The mount 50 is offset in position on the first display monitor 10 so as to provide balance of the portable workstation 100 subsequent being deployed to its second position. While the mount 50 is illustrated herein as being in a certain position, it is contemplated within the scope of the present invention that the mount 50 could be placed in alternate locations. Furthermore, it is contemplated within the scope of the present invention that the portable workstation 100 could employ more than one mount 50. It should be understood within the scope of the present invention that the first display monitor 10 and second display monitor 20 are movably coupled to the mount 50 so as to facilitate the ability to tilt and rotate the first display monitor 10 and second display monitor 20 as needed for desired position during use thereof.

The portable workstation 100 further includes a keyboard 60. The keyboard 60 is movably secured to the mount 50 utilizing suitable durable techniques. The keyboard 60 is movable so as to be intermediate the first display monitor 10 and second display monitor 20 when the portable workstation 100 is in its first position to being horizontal in manner when the portable workstation 100 is in its second position. It should be understood within the scope of the present invention that the keyboard is physically decoupled from the portable workstation 100 during use and employs suitable wireless communication protocols to communicate with the portable workstation 100.

The portable workstation 100 is operably coupled to a portable computing device(not particularly illustrated herein) utilizing suitable techniques such as but not limited to Bluetooth or other wireless protocols. The first display monitor 10 and second display monitor 20 are operated via control panel 70 wherein the control panel 70 provides the necessary electronics and interface to provide operation of the portable workstation 100. The control panel 70 includes functions such as but not limited to powering off and on of the first display monitor 10 and second display monitor, brightness, contrast and other similar features. It should be further understood within the scope of the present invention that the control panel 70 includes an integrated power supply that is operable to further supply power for a portable computing device if required.

The second display monitor 20 further includes a mouse compartment 90 formed in the rear thereof. The mouse compartment 90 is configured to store an exemplary mouse 99 when not in use. The mouse compartment 90 is sized so as to accommodate various styles of computer mouse. While the mouse compartment 90 is illustrated herein as being formed in the second display monitor 20, it should be understood within the scope of the present invention that the mouse compartment 90 could be formed in the first display monitor 10.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A portable workstation configured to be operably coupled to a portable computing device wherein the portable workstation comprises:
a first display monitor, said first display monitor having a housing, said first display monitor having a screen mounted within said housing,
a second display monitor, said second display monitor having a housing, said second display monitor having a screen mounted within said housing;
a control panel, said control panel being mounted within said housing of said second display monitor, said control panel being operably coupled to said first display monitor and said second display monitor providing operation thereof;
at least one movement member, said at least one movement member being operably coupled to said housing of said first display monitor and said housing of said second display monitor; and
wherein said first display monitor and said second display monitor are movable between a first position and a second position.

2. The portable workstation configured to be operably coupled to a portable computing device as recited in claim 1, and further including at least one mount, said at least one mount being secured to a bottom of either the housing of the second display monitor or a bottom of the housing of the first display monitor.

3. The portable workstation configured to be operably coupled to a portable computing device as recited in claim 2, and further including a keyboard, said keyboard configured to be operably coupled to a portable computing device.

4. The portable workstation configured to be operably coupled to a portable computing device as recited in claim 3, wherein in said first position, said screen of said first display monitor and said screen of said second display monitor are facing so as to place the portable workstation in a folded orientation.

5. The portable workstation configured to be operably coupled to a portable computing device as recited in claim 4, wherein in said second position said first display monitor and said second display monitor are axially aligned so as to provide an orientation such that the screen of the first display monitor and the screen of the second display monitor are facing in a same direction.

6. The portable workstation configured to be operably coupled to a portable computing device as recited in claim 5, wherein said keyboard is intermediate the first display monitor and the second display monitor during said first position.

7. A portable workstation configured to be operably coupled to a portable computing device wherein the portable workstation comprises:
a first display monitor, said first display monitor having a housing, said housing having an inner perimeter edge, said first display monitor having a screen mounted within said housing,
a second display monitor, said second display monitor having a housing, said housing of said second display monitor having an inner perimeter edge, said second display monitor having a screen mounted within said housing;
a control panel, said control panel being mounted within said housing of said second display monitor, said control panel having necessary electronics to provide power for said first display monitor, said second display monitor and provide wireless communication to the portable computing device;
a first movement member and a second movement member, said first movement member and said second movement member being secured to said inner perimeter edge of said housing of said first display monitor and said second display monitor, said first movement member being proximate a top edge of the portable workstation, said second movement member being proximate a bottom edge of the portable workstation;
a keyboard, said keyboard being operably coupled to the portable workstation; and
wherein said first display monitor and said second display monitor are movable between a first position and a second position.

8. The portable workstation configured to be operably coupled to a portable computing device as recited in claim 7, wherein in said first position, said screen of said first display monitor and said screen of said second display monitor are facing so as to place the portable workstation in a folded orientation.

9. The portable workstation configured to be operably coupled to a portable computing device as recited in claim 8, and further including a mount, said mount being secured said bottom edge of said housing of said first display monitor, said mount being positioned proximate the inner perimeter edge of said housing of said first display monitor.

10. The portable workstation configured to be operably coupled to a portable computing device as recited in claim 9, wherein in said second position said first display monitor and said second display monitor are axially aligned so as to provide an orientation such that the screen of the first display monitor and the screen of the second display monitor are facing in a same direction.

11. The portable workstation configured to be operably coupled to a portable computing device as recited in claim 10, wherein said keyboard is intermediate the first display monitor and the second display monitor during said first position.

12. The portable workstation configured to be operably coupled to a portable computing device as recited in claim 11, wherein said first display monitor and said second display monitor are twenty four inches.

13. The portable workstation configured to be operably coupled to a portable computing device as recited in claim 12, and further including a mouse compartment, said mouse compartment being formed in said second display monitor on a rear surface thereof, said mouse compartment configured to receive and store a computer mouse.
